(19) United States
(12) Patent Application Publication
(10) Pub. No.: US 2009/0025014 A1
(43) Pub. Date: Jan. 22, 2009

(54) DATA TRANSFER METHOD AND SYSTEM

(76) Inventors: Liyao Chen, Shenzhen (CN); Bin Xiao, Shenzhen (CN); Mingjun Xu, Shenzhen (CN)

Correspondence Address: BRINKS HOFER GILSON & LIONE, P.O. BOX 10395, CHICAGO, IL, 60610, US

(21) Appl. No.: 12/176,187

(22) Filed: Jul. 18, 2008

(30) Foreign Application Priority Data
Jul. 20, 2007 (CN) 200710129984.3
Mar. 18, 2008 (CN) PCT/CN2008/070521

(51) Int. Cl. G06F 13/00

(52) U.S. Cl. 719/326

(57) ABSTRACT

A data transfer method and an Internet Small Computer Systems Interface controller are disclosed. At least one mirror iSCSI controller is preset for each iSCSI controller. The mirror iSCSI controller detects failure of the mirrored iSCSI controller corresponding to the mirror iSCSI controller, and adds service information of the mirrored iSCSI controller to the mirror iSCSI controller. The mirror iSCSI controller receives a log-in request sent from an iSCSI host which originally has logged in the mirrored iSCSI controller. The mirror iSCSI controller conducts data transfer with the iSCSI host in accordance with the service information.

This application claims the priority of Chinese Patent Application No. 200710129984.3, entitled “DATA TRANSFER METHOD AND SYSTEM AND INTERNET SMALL COMPUTER SYSTEMS INTERFACE CONTROLLER”, and filed with the Chinese Patent Office on Jul. 20, 2007, and the priority of International patent application No. PCT/CN2008/070521, entitled “DATA TRANSFER METHOD AND SYSTEM AND INTERNET SMALL COMPUTER SYSTEMS INTERFACE CONTROLLER”, and filed on Mar. 18, 2008, which are hereby incorporated by reference in their entirety.

### FIELD OF THE INVENTION

The present invention relates to the field of data transfer technologies and in particular to a data transfer method and system.

### BACKGROUND

After stepping into the information age, the rapidly increasing amount of information has posed higher requirements on the capacity, performance and reliability of storage devices. A host and storage devices are typically networked in a distributed manner for the purposes of resource sharing, centralized management and security. Connection technologies in support of a high bandwidth and a long distance are particularly important for this networking manner.

The Internet Small Computer Systems Interface (iSCSI) is a standard established by the Internet Engineering Task Force in 2003 for mapping an SCSI data block into an Ethernet data packet. The iSCSI can build an IP storage Local Area Network with use of the Ethernet. With this method, the iSCSI can overcome the limitation of a direct connection with a storage device so as to share storage resources across different servers and regions and to extend a storage capacity without any outage.

FIG. 1 illustrates a flow chart of data transfer in conventional iSCSI technology. As illustrated in FIG. 1, the detailed steps are as follows.

Step 101: An iSCSI controller runs an iSCSI target service program corresponding to an IP address of a service network port.

Step 102: An iSCSI host sends a log-in request to the iSCSI controller in accordance with the IP address and the port number of the iSCSI controller, which are configured at the iSCSI host.

Step 103: The iSCSI controller receives the log-in request and starts a log-in process and sends back a log-in success response at the end of the process.

Step 104: The iSCSI host transfers data with the iSCSI controller.

The iSCSI host can write data to and read data from the iSCSI controller.

As can be seen from the flow above, a single-controller mode is adopted for an iSCSI target. i.e., the iSCSI host can be connected with only one iSCSI controller. When a failure occurs with a connection link between the iSCSI host and the iSCSI controller or with the iSCSI controller per se, the consistency of data and the continuity of service can not be guaranteed, thereby resulting in poor stability and reliability of data communication.

### SUMMARY

Some embodiments of the invention provide a data transfer method and system and an iSCSI controller to improve reliability of data transfer between an iSCSI host and the iSCSI controller.

Technical solutions of the embodiments of the invention are achieved as follows.

It shall be noted that in the embodiments of the invention, if an iSCSI controller b is a mirror iSCSI controller of an iSCSI controller a, the iSCSI controller a is referred to as a mirrored iSCSI controller of the iSCSI controller b.

This method presets at least one mirror iSCSI controller for each iSCSI controller and includes:

detecting, by the mirror iSCSI controller, failure of the mirrored iSCSI controller corresponding to the mirror iSCSI controller;

adding service information of the mirrored iSCSI controller to the mirror iSCSI controller;

receiving, by the mirror iSCSI controller, a log-in request sent from an iSCSI host which originally has logged in the mirrored iSCSI controller; and

processing the log-in request and taking the place of the mirrored iSCSI. controller.

A data transfer system includes:

an iSCSI host adapted to re-initiate a log-in request upon detection of failure of a mirrored iSCSI controller which the iSCSI host logs in, to log in a mirror iSCSI controller corresponding to the mirrored iSCSI controller, and to conduct data transfer with the mirror iSCSI controller; and

the mirror iSCSI controller adapted to add service information of the mirrored iSCSI controller upon detection failure of the corresponding mirrored iSCSI controller, to receive the log-in request sent from the iSCSI host which originally has logged in the mirrored iSCSI controller, and to conduct data transfer with the iSCSI host which originally has logged in the mirrored iSCSI controller in accordance with the service information.

An iSCSI controller includes:

a mirror failure processing module adapted to add service information of a corresponding mirrored iSCSI controller upon detection of failure of the mirrored iSCSI controller; and

a data processing module adapted to conduct data transfer with an iSCSI host, which originally has logged in the mirrored iSCSI controller.

As compared with the existing technology, the disclosed embodiments preset at least one mirror iSCSI controller for each iSCSI controller. The mirror iSCSI controller adds service information of its mirrored iSCSI controller upon detection of failure of the mirrored iSCSI controller, receives a log-in request sent from the iSCSI host which originally has logged in the mirrored iSCSI controller, accepts the log-in request, and conducts data transfer with the iSCSI host in accordance with the service information, thereby improving reliability of data communication.

### BRIEF DESCRIPTION OF THE DRAWINGS

FIG. 1 illustrates a flow chart of data transfer with use of an iSCSI technology in the existing technology;

FIG. 2 illustrates a flow chart in which an iSCSI host logs in and conducts data transfer with a homing iSCSI controller which the iSCSI host should log in according to an embodiment of the invention;

FIG. 3 illustrates a flow chart in which data transfer is switched to a mirror iSCSI controller when an iSCSI controller which an iSCSI host has originally logged in fails according to an embodiment of the invention;

FIG. 4 illustrates a flow chart of data transfer after a homing iSCSI controller recovers according to an embodiment of the invention;

FIG. 5 illustrates a schematic diagram of typical networking for data transfer with an iSCSI technology according to an embodiment of the invention;

FIG. 6 illustrates a schematic diagram of components in a data transfer system according to an embodiment of the invention;

FIG. 7 illustrates a schematic diagram of a structure of a mirror failure processing module in an iSCSI controller according to an embodiment of the invention;

FIG. 8 illustrates a schematic diagram of a structure of a mirror recovery processing module in an iSCSI controller according to an embodiment of the invention; and

FIG. 9 illustrates a schematic diagram of a structure of a recovery processing module in an iSCSI controller according to an embodiment of the invention.

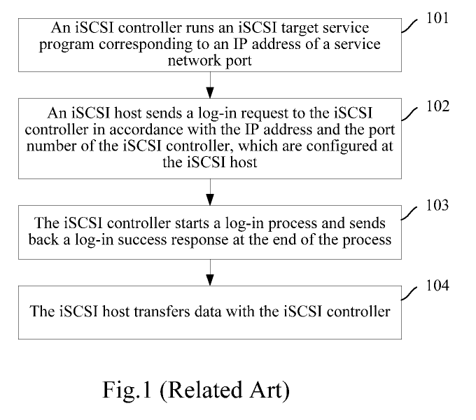

### DETAILED DESCRIPTION OF THE INVENTION

In some embodiments of the invention, for each iSCSI controller, at least one iSCSI controller is selected in advance from all other iSCSI controllers as a mirror iSCSI controller of the iSCSI controller. Different IP addresses are set for the iSCSI controller and its mirror iSCSI controller. An IP address and a port number of an iSCSI controller accessible to an iSCSI host are configured on the iSCSI host. The same name can be set for the iSCSI controller and its mirror iSCSI controller. A homing iSCSI controller can be set for each iSCSI host. The homing iSCSI controller stores the relationship between the identifier of the iSCSI host (e.g., an initiator name) and the IP address of the homing iSCSI controller.

Some embodiments of the invention will be detailed below, taking it as an example that an iSCSI controller B is a mirror iSCSI controller of an iSCSI controller A, wherein the iSCSI controller A is a homing iSCSI controller of an iSCSI host 1 configured with an IP address and a port number of the iSCSI controller B.

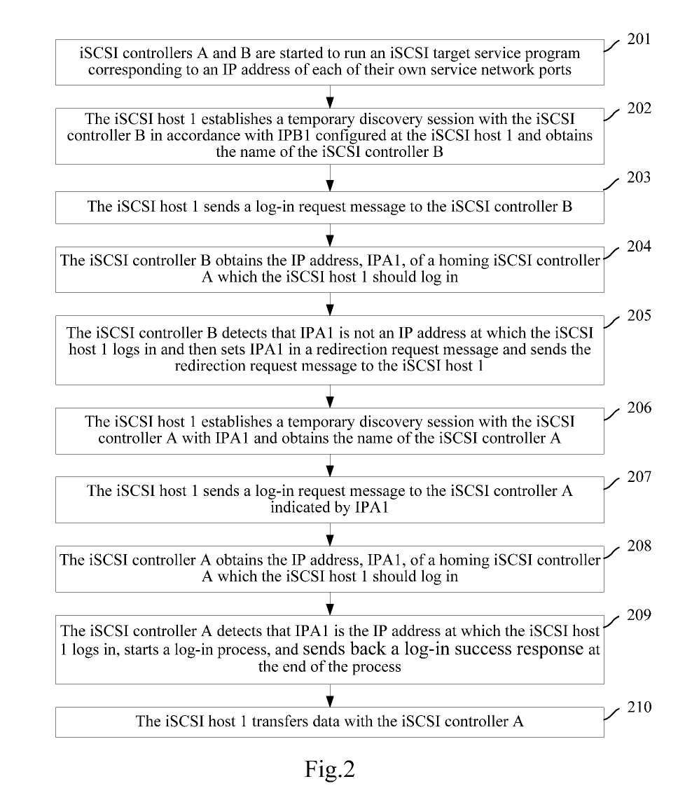

FIG. 2 illustrates a flow chart in which an iSCSI host logs in and transfers data with a homing iSCSI controller which the iSCSI host should log in according to an embodiment of the invention. As illustrated in FIG. 2, the detailed steps are as follows.

Step 201: The iSCSI controller A is starts to run an iSCSI target service program corresponding to an IP address of each of its own service network ports, and the iSCSI controller B is started to run an iSCSI target service program corresponding to an IP address of each of its own service network ports.

At least one service network port is provided on each iSCSI controller and each service network port is configured with at least one IP address.

Step 202: The iSCSI host 1 establishes a temporary discovery session with the iSCSI controller B in accordance with the IP address, IPB1, of the iSCSI controller B configured at the iSCSI host 1, and obtains the name of the iSCSI controller B through the session.

Step 203: The iSCSI host 1 sends to the iSCSI controller B a log-in request carrying the initiator name of the iSCSI host 1.

The iSCSI host 1 may be configured with one IP address or two or more IP addresses of the iSCSI controller B and send the log-in request to any of the IP addresses configured at the iSCSI host.

Step 204: The iSCSI controller B receives the log-in request message and obtains the IP address, IPA1, of a homing iSCSI controller which the iSCSI host 1 should log in, in accordance with the initiator name of the iSCSI host 1 carried in the message and its stored relationship between the initiator name and the IP address of the homing iSCSI controller.

The relationship between the initiator name of the iSCSI host and the IP address of the homing iSCSI controller may include an algorithm to calculate the IP address of the homing iSCSI controller by taking the initiator name of the iSCSI host as a parameter.

Step 205: The iSCSI controller B detects that IPA1 is not the IP address at which the iSCSI host 1 logs in and then sets IPA1 in a redirection request message and sends the redirection request message to the iSCSI host 1.

The IP address at which the iSCSI host 1 logs in is IPB1 with which the iSCSI host 1 sends the log-in request in the step 202.

Step 206: The iSCSI host 1 receives the redirection request message, establishes a temporary discovery session with the iSCSI controller A which IPA1 indicates in accordance with IPA1 carried in the redirection request and obtains the name of the iSCSI controller A through the session.

Step 207: The iSCSI host 1 sends to the iSCSI controller A indicated by IPA1 a log-in request carrying the initiator name of the iSCSI host 1.

Step 208: The iSCSI controller A receives the log-in request message and obtains the IP address, IPA1, of a homing iSCSI controller A which the iSCSI host 1 should log in, in accordance with the initiator name of the iSCSI host 1 carried in the message and its stored relationship between the initiator name and the IP address of the homing iSCSI controller.

Step 209: The iSCSI controller A detects that IPA1 is the IP address at which the iSCSI host 1 logs in, starts a log-in process and sends back a log-in success response at the end of the process.

The log-in process includes negotiation about operative parameters, and security authentication, etc.

Step 210: The iSCSI host 1 transfers data with the iSCSI controller A. The iSCSI controller A may store data sent from the iSCSI host 1 into a storage medium accessible to both the iSCSI controller A and the iSCSI controller B, and the iSCSI host 1 can read the data from the storage medium.

As can be seen from the flow illustrated in FIG. 2, each iSCSI host is provided with a homing iSCSI controller. The iSCSI host initially logs in the homing iSCSI controller, thereby ensuring that traffic of the iSCSI hosts over different iSCSI controllers is averagely distributed and hence load sharing among the iSCSI controllers.

Descriptions will be made below to a process in which when a failure occurs with a connection link between the iSCSI host 1 and the homing iSCSI controller, i.e. the iSCSI controller A or with the iSCSI controller A per se, i.e. the iSCSI controller A fails, the mirror iSCSI controller of the iSCSI controller A, i.e. the iSCSI controller B takes the place of the iSCSI controller A for data transfer with the iSCSI host which originally has logged in the iSCSI controller A.

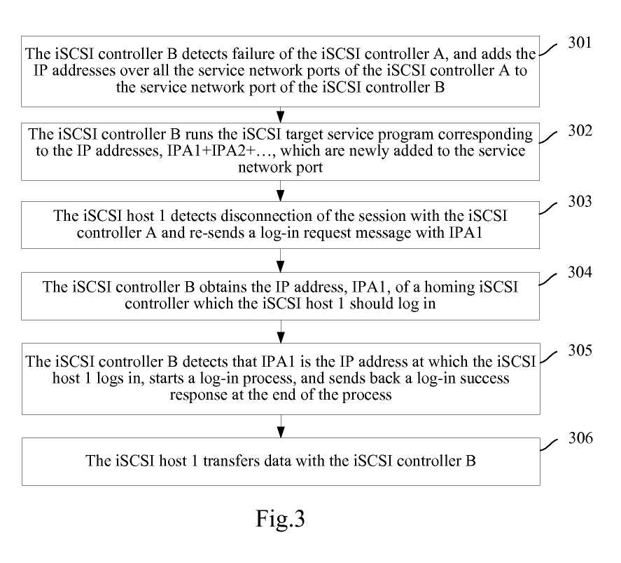

FIG. 3 illustrates a flow chart in which data transfer is switched to a mirror iSCSI controller when an iSCSI controller which an iSCSI host has originally logged in fails according to an embodiment of the invention. A s illustrated in FIG. 3, the detailed steps are as follows.

Step 301: The iSCSI controller B detects failure of the iSCSI controller A, and adds the IP addresses over all the service network ports of the iSCSI controller A to the service network port of the iSCSI controller B.

Failure of the iSCSI controller A in this step refers to when the iSCSI controller A can not conduct data transfer with the iSCSI host which logs in the iSCSI controller A. The iSCSI controller A may fail due to partial malfunction or restart of the iSCSI controller A. In the case of a partial malfunction of the iSCSI controller A, the iSCSI controller A can notify the iSCSI controller B in time upon detection of its own failure. In the case of restart of the iSCSI controller A, the iSCSI controller B can know that the iSCSI controller A has failed due to no reception of any handshake message sent from the iSCSI controller A.

Information on the IP address over the service network port of each iSCSI controller is stored in a storage space accessible to both the iSCSI controller and its mirror iSCSI controller. Therefore, the iSCSI controller B may obtain the IP addresses over all the service network ports of the iSCSI controller A from the storage space accessible to both of the iSCSI controllers.

Upon determination of its own failure, the iSCSI controller A can stop the iSCSI target service program running at the IP addresses of its all service network ports and delete the IP addresses over its all service network ports.

After this step is executed, the IP addresses of the service network ports of the iSCSI controller B include IPA1+IPA2+ . . . and IPB1+IPB2+ . . . , where IPA1+IPA2+ . . . denote the IP addresses over all the service network ports formerly on the iSCSI controller A, and IPB1+IPB2+. . . denote the IP addresses over all the service network ports on the iSCSI controller B.

Step 302: The iSCSI controller B runs the iSCSI target service program corresponding to the IP addresses, IPA1+IPA2+ . . . , which are newly added over the service network port.

Step 303: The iSCSI host 1 detects disconnection of the session with the iSCSI controller A, takes an IP address at which a recent successful log-in occurs, i.e. IPA1 in this embodiment, as a destination address, and re-sends a log-in request carrying the initiator name of the iSCSI host 1.

Typically, the iSCSI host 1 may send the log-in request to an IP address used for the recent successful log-in.

Step 304: The iSCSI controller B receives the log-in request message and obtains the IP address, IPA1, of a homing iSCSI controller which the iSCSI host 1 should log in, in accordance with the initiator name of the iSCSI host 1 carried in the log-in request message and its stored relationship between the initiator name and the IP address of the homing iSCSI controller.

Step 305: The iSCSI controller B detects that IPA1 is the IP address at which the iSCSI host 1 logs in, starts a log-in process, and sends back a log-in success response at the end of the process.

The log-in process in this step is the same as that in the step 209.

Step 306: The iSCSI host 1 transfers data with the iSCSI controller B.

The iSCSI controller B can store data sent from the iSCSI host 1 into a storage medium accessible to both the iSCSI controller B and the iSCSI controller A, and the iSCSI host can read the data from the storage medium.

As can be seen from the flow illustrated in FIG. 3, when the iSCSI controller A in which the iSCSI host 1 logs fails, the mirror iSCSI controller of the iSCSI controller A (the iSCSI controller B) adds the IP address over the service network port of the iSCSI controller A to the service network port of the mirror iSCSI controller, and runs an iSCSI target service program corresponding to the newly added IP address. Then, the iSCSI host 1 re-sends a log-in request, logs in the mirror iSCSI controller, and conducts data transfer with the mirror iSCSI controller, thereby ensuring consistency of the data and continuity of the service.

When the homing iSCSI controller of the iSCSI host 1 (the iSCSI controller A) recovers, the iSCSI controller B can disconnect the session with the iSCSI host which originally has logged in the iSCSI controller A for load sharing, so that the iSCSI host 1 will log in the iSCSI controller A again. A description will be made below to an embodiment of data transfer when the homing iSCSI controller recovers.

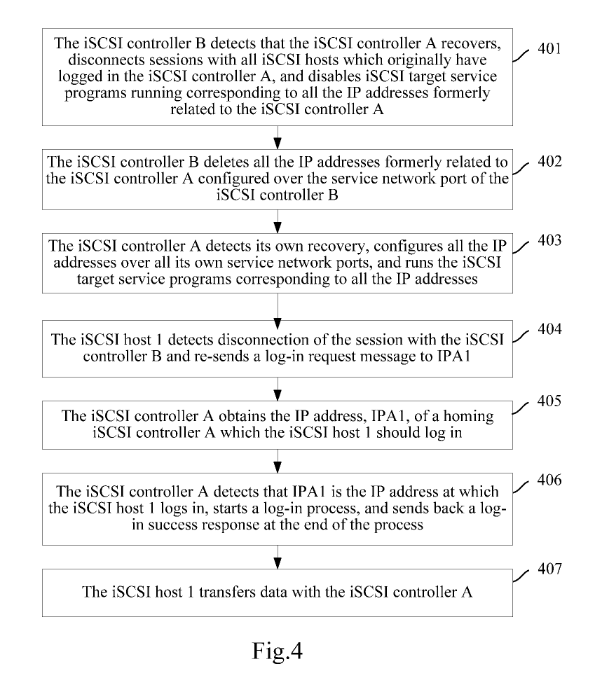

FIG. 4 illustrates a flow chart of data transfer after the homing iSCSI controller recovers according to an embodiment of the invention. A s illustrated in FIG. 4, the detailed steps are as follows.

Step 401: The iSCSI controller B detects that the iSCSI controller A recovers, disconnects session with all iSCSI hosts which originally log in the iSCSI controller A, and disables iSCSI target service programs running corresponding to all the IP addresses formerly related to the iSCSI controller A.

Step 402: The iSCSI controller B deletes all the IP addresses formerly related to the iSCSI controller A configured over the service network port of the iSCSI controller B.

Step 403: The iSCSI controller A detects its own recovery, configures the IP addresses of the iSCSI controller A over all its own service network ports, and runs the iSCSI target service program corresponding to the configured IP addresses.

All the IP addresses configured over the service network port of each iSCSI controller are stored in a storage space accessible to both the iSCSI controller and its mirror iSCSI controller. Therefore, the iSCSI controller A can obtain the IP address configured over the service network port of the iSCSI controller A from the storage space accessible to both of the iSCSI controllers.

Step 404: The iSCSI host 1 detects disconnection of the session with the iSCSI controller B, and re-sends, to IPA1, a log-in request carrying the initiator name of the iSCSI host 1.

Step 405: The iSCSI controller A receives the log-in request message, and obtains the IP address, IPA1, of a homing iSCSI controller A which the iSCSI host 1 should log in, in accordance with the initiator name of the iSCSI host 1 carried in the message and its stored relationship between the initiator name and the IP address of the homing iSCSI controller.

Step 406: The iSCSI controller A detects that IPA1 is the IP address at which the iSCSI host 1 logs in, starts a log-in process, and sends back a log-in success response at the end of the process.

The log-in process in this step is the same as that in the step 209.

Step 407: The iSCSI host 1 transfers data with the iSCSI controller A.

The embodiments illustrated in FIG. 2 to FIG. 4 relate to a scenario in which the iSCSI controller B is the mirror iSCSI controller of the iSCSI controller A. Alternatively, the iSCSI controller A may also be set as the mirror iSCSI controller of the iSCSI controller B at the same time. Then, the iSCSI controller A and the iSCSI controller B can be referred to as an opposite iSCSI controller of one another.

Furthermore, in the embodiments illustrated in FIG. 2 to FIG. 4, the iSCSI A is provided with only one mirror iSCSI controller, the iSCSI controller B. In other solution, each iSCSI controller may also be provided with two or more mirror iSCSI controllers. Each iSCSI controller may mirror data sent from an iSCSI host to all its mirror iSCSI controllers. When the iSCSI controller fails, one mirror iSCSI controller may be selected from those mirror iSCSI controllers in normal operation to take the place of the iSCSI controller for data transfer with the iSCSI host which originally has logged in the iSCSI controller. The selected mirror iSCSI controller may be one of all the mirror iSCSI controllers with the minimum load. For example, in the case of a plurality of mirror iSCSI controllers, it is possible to decide which mirror iSCSI controller to take on the service of the failing iSCSI controller in an arbitration manner.

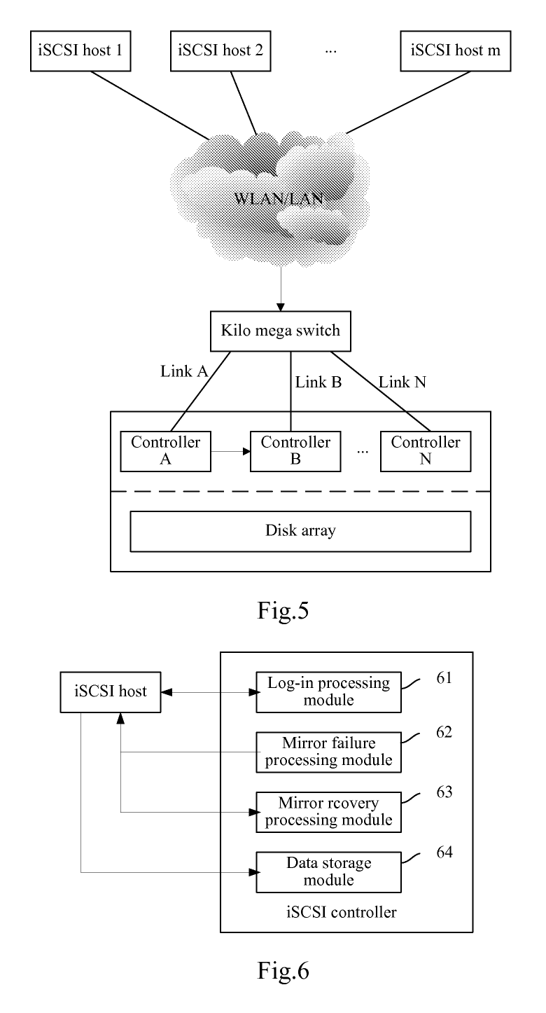

According to the embodiments illustrated in FIG. 2 to FIG. 4, FIG. 5 illustrates a typical networking diagram of data storage system with use of the iSCSI technology according to an embodiment of the invention. As illustrated in FIG. 5, a mirrored iSCSI target service program is running on a controller A, a controller B, . . . , a controller N, and an iSCSI host 1, an iSCSI host 2, . . . , an iSCSI host m establish a session with an iSCSI controller over a Wide Area Network (WAN) or a Local Area Network (LAN). There is only one session to be established between an iSCSI host and an iSCSI target (including a mirrored iSCSI controller and a mirror iSCSI controller). As illustrated in FIG. 5, for the iSCSI host 1, the same name appears to the iSCSI host 1 regardless of whether the iSCSI host 1 establishes a session with the iSCSI controller A or the iSCSI controller B. Therefore, the iSCSI host 1 will not be aware of any change of the iSCSI controller.

FIG. 6 illustrates a schematic diagram of components in a data storage system according to an embodiment of the invention. As illustrated in FIG. 6, the system includes an iSCSI host and an iSCSI controller.

When being started, the iSCSI host obtains, in accordance with an IP address of the iSCSI controller configured at the iSCSI host, a name of the iSCSI controller which the IP address identifies, and sends to the iSCSI controller a log-in request carrying the initiator name of the iSCSI host. If the iSCSI host receives a redirection request message carrying an IP address sent from the iSCSI controller, the iSCSI host obtains the name of an iSCSI controller which the IP address carried in the redirection request message identifies, and sends a log-in request to the iSCSI controller. After receiving a log-in success notification sent from the iSCSI controller which the IP address carried in the redirection request message identifies, the iSCSI host conducts data transfer with the iSCSI controller. Upon detection of disconnection of the session with the iSCSI controller, the iSCSI host re-sends a log-in request message. As an example, the iSCSI host may re-send the log-in request message to an IP address used for its recent successful log-in.

As illustrated in FIG. 6, the iSCSI controller includes a log-in processing module 61, a mirror failure processing module 62, a mirror recovery processing module 63, and a data processing module 64.

The log-in processing module 61 receives the log-in request message sent from the iSCSI host, and obtains an IP address of a homing iSCSI controller which the iSCSI host should log in, in accordance with the initiator name of the iSCSI host carried in the message and its own stored relationship between the initiator name and the IP address of the homing iSCSI controller. If the IP address is the IP address at which the iSCSI host logs in, the log-in processing module starts a log-in process and sends back a log-in success response at the end of the process. Otherwise, the module sends back a redirection request carrying the obtained IP address to the iSCSI host.

The mirror failure processing module 62 detects failure of a mirrored iSCSI controller of the iSCSI controller, adds an IP address over a service network port of the mirrored iSCSI controller to the iSCSI controller, and runs an iSCSI target service program corresponding to the IP address.

The mirror recovery processing module 63 detects that the mirrored iSCSI controller of the iSCSI controller recovers, disconnects the session of the iSCSI controller with the iSCSI host which originally has logged in the mirrored iSCSI controller, disables the iSCSI target service program corresponding to the IP address of the mirrored iSCSI controller over the service network port of the iSCSI controller, and deletes the IP address of the mirrored iSCSI controller over the service network port of the iSCSI controller.

The data processing module 64 receives data sent from the iSCSI host which originally has logged in the mirrored iSCSI controller of the present controller and stores the data into a cache.

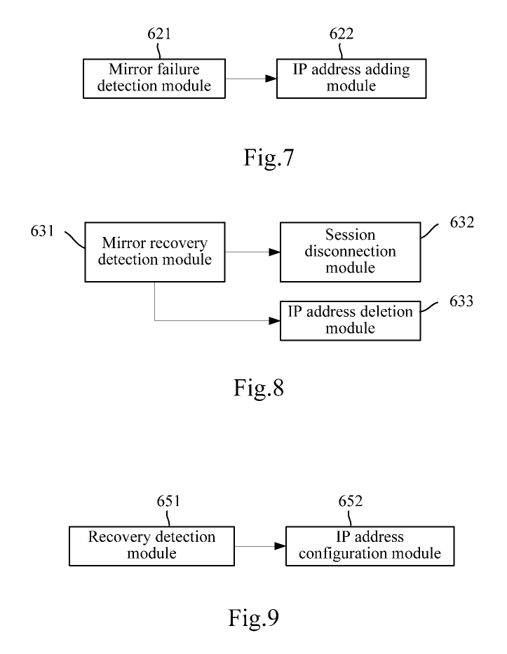

As illustrated in FIG. 7, the mirror failure processing module 62 includes a mirror failure detection module 621 and an IP address adding module 622.

The mirror failure detection module 621 detects failure of the mirrored iSCSI controller of the iSCSI controller, and sends a mirror failure indication to the IP address adding module 622.

The IP address adding module 622 receives the mirror failure indication sent from the mirror failure detection module 621, adds the IP address of the mirrored iSCSI controller of the iSCSI controller to the service network port of the iSCSI controller, and runs the iSCSI target service program corresponding to the IP address.

As illustrated in FIG. 8, the mirror recovery processing module 63 includes a mirror recovery detection module 631, a session disconnection module 632, and an IP address deletion module 633.

The mirror recovery detection module 631 is adapted to send a mirror recovery indication to the session disconnection module 632 and the IP address deletion module 633, upon detection of that the mirrored iSCSI controller of the iSCSI controller recovers.

The session disconnection module 632 is adapted to disconnect the session of the iSCSI controller with the iSCSI host which originally has logged in the mirrored iSCSI controller of the iSCSI controller upon reception of the mirror recovery indication sent from the mirror recovery detection module 631.

The IP address deletion module 633 is adapted to disable the iSCSI target service program corresponding to the IP address of the mirrored iSCSI controller over the service network port of the iSCSI controller and delete the IP address of the mirrored iSCSI controller configured over the service network port of the iSCSI controller upon reception of the mirror recovery indication sent from the mirror recovery detection module 631.

Furthermore, the iSCSI controller in one embodiment of the invention further includes a failure processing module and a recovery processing module.

The failure processing module is adapted to disable the iSCSI target service program running at the IP address of the service network port and delete the IP address over the service network port upon determination of failure of the iSCSI controller.

The recovery processing module configures the IP address over the service network port of the iSCSI controller and runs the iSCSI target service program corresponding to the IP address of the service network port of the iSCSI controller upon determination that the iSCSI controller recovers.

As illustrated in FIG. 9, the recovery processing module includes a recovery detection module 651 and an IP address configuration module 652.

The recovery detection module 651 is adapted to send a failure recovery indication to the IP address configuration module 652 upon detection of that the iSCSI controller recovers from failure.

The IP address configuration module 652 is adapted to configure the IP address over the service network port of the iSCSI controller and to run the iSCSI target service program corresponding to the IP addresses upon reception of the failure recovery indication sent from the recovery detection module 651.

As can be seen from the embodiments above, when the iSCSI controller fails, the mirror iSCSI controller of the iSCSI controller can add the IP address over the service network port of the iSCSI controller to its own service network port, and runs the iSCSI target service program corresponding to the IP address. Thereafter, the iSCSI host logs in the mirror iSCSI controller, and conducts data transfer with the mirror iSCSI controller, thereby achieving consistency of data and continuity of the service and improving reliability and stability of data communication. Furthermore, a homing iSCSI controller can be set for each iSCSI host for load sharing. Additionally, the same name is used for the iSCSI controller and the mirror iSCSI controller, so that the process of switching the iSCSI controllers will be transparent to a user.

The foregoing descriptions are merely illustrative of the processes and method embodiments of the invention but not limitative to the invention. Any modifications, alternatives and adaptations made without departing from the spirit and principle of the invention shall come into the scope of the invention as defined in the appended claims.

What is claimed is:

1. A data transfer method, comprising:
detecting, by a mirror iSCSI controller, failure of the mirrored iSCSI controller corresponding to the mirror iSCSI controller;
adding service information of the mirrored iSCSI controller to the mirror iSCSI controller;
receiving, by the mirror iSCSI controller, a log-in request sent from an iSCSI host, which originally has logged in the mirrored iSCSI controller; and
processing the log-in request and transferring data with the iSCSI host according to the service information of the mirrored iSCSI controller.

2. The method according to claim 1, further comprising:
presetting each iSCSI host to belong to one of the mirrored iSCSI controllers; and
logging in, by the iSCSI host, the mirrored iSCSI controller to which the iSCSI host belongs and transferring data with the mirrored iSCSI controller.

3. The method according to claim 2, further comprising: disabling, by the mirrored iSCSI controller, an iSCSI target service program running at an IP address of a service network port upon detection of failure.

4. The method according to claim 3, further comprising:
configuring, by the mirrored iSCSI controller, the IP address over the service network port and running the iSCSI target program corresponding to the IP address upon detection of recovery from failure.

5. The method according to claim 3, further comprising:
detecting, by the iSCSI host, disconnection of data transfer with the mirror iSCSI controller, re-initiating a log-in request, logging in the iSCSI controller, and conducting data transfer with the iSCSI controller.

6. The method according to claim 4, further comprising:
detecting, by the iSCSI host, disconnection of data transfer with the mirror iSCSI controller, re-initiating a log-in request, logging in the iSCSI controller, and conducting data transfer with the iSCSI controller.

7. The method according to claim 1, wherein the adding of the service information of the mirrored iSCSI controller to the mirror iSCSI controller comprises: adding the IP address of the mirrored iSCSI controller to a service network port of the mirror iSCSI controller, and running an iSCSI target service program corresponding to the added IP address.

8. The method according to claim 7, further comprising:
detecting, by the mirror iSCSI controller, that the mirrored iSCSI controller recovers;
disconnecting, by the mirror iSCSI controller, the data transfer with the iSCSI host which originally has logged in the mirrored iSCSI controller; and
disabling, by the mirror iSCSI controller, the iSCSI target service program running at the IP address of the mirrored iSCSI controller over the service network port, and deleting the IP address of the mirrored iSCSI controller over the service network port.

9. The method according to claim 1, further comprising: presetting the same name for the iSCSI controller and the corresponding mirror iSCSI controller.

10. A data transfer system, comprising:
an iSCSI host adapted to re-send a log-in request when disconnection with a mirrored iSCSI controller that the iSCSI host logs in is detected; and
a mirror iSCSI controller adapted to add service information of the mirrored iSCSI controller upon detection failure of the corresponding mirrored iSCSI controller, to receive the log-in request sent from the iSCSI host, and to conduct data transfer with the iSCSI host in accordance with the service information.

11. An iSCSI controller, comprising:
a mirror failure processing module adapted to add service information of a corresponding mirrored iSCSI controller upon detection of failure of the mirrored iSCSI controller; and
a data processing module adapted to conduct data transfer with an iSCSI host which originally has logged in the mirrored iSCSI controller.

12. The iSCSI controller according to claim 11, wherein the mirror failure processing module comprises:
a mirror failure detection module adapted to send a mirror failure indication upon detection of failure of the corresponding mirrored iSCSI controller; and
an IP address adding module adapted to receive the mirror failure indication, to add an IP address of the mirrored iSCSI controller to a service network port of the iSCSI controller, and to run an iSCSI target service program corresponding to the IP address.

13. The iSCSI controller according to claim 11, further comprising:
a mirror recovery processing module adapted to disconnect the session between the iSCSI host which originally has logged in the mirrored iSCSI controller and mirror iSCSI controller upon detection of that the mirrored iSCSI controller recovers, and to delete the service information of the mirrored iSCSI controller on the iSCSI controller.

14. The iSCSI controller according to claim 13, wherein the mirror recovery processing module comprises:
a mirror recovery detection module adapted to send a mirror recovery indication upon detection of that the mirrored iSCSI controller recovers;
a session disconnection module adapted to disconnect the session between the iSCSI controller and the iSCSI host that originally has logged in the mirrored iSCSI controller upon reception of the mirror recovery indication; and
an IP address deletion module adapted to disable the iSCSI target service program running at an IP address of the mirrored iSCSI controller over a service network port of the iSCSI controller and to delete the IP address of the mirrored iSCSI controller configured over the service network port of the iSCSI controller upon reception of the mirror recovery indication.

15. The iSCSI controller according to claim 11, further comprising:
a failure processing module adapted to disable an iSCSI target service program running at an IP address of a service network port of the iSCSI controller upon detection of failure of the iSCSI controller and to delete the IP address of the service network port.

16. The iSCSI controller according to claim 11, further comprising:
a recovery processing module adapted to configure service information on the iSCSI controller upon detection of that the iSCSI controller recovers from failure.

17. The iSCSI controller according to claim 15, further comprising:
a recovery processing module adapted to configure service information on the iSCSI controller upon detection of that the iSCSI controller recovers from failure.

18. The iSCSI controller according to claim 16, wherein the recovery processing module comprises:
a recovery detection module adapted to send a failure recovery indication upon detection of that the iSCSI controller recovers from failure; and
an IP address configuration module adapted to receive the failure recovery indication sent from the recovery detection module, to configure an IP address over a service network port of the iSCSI controller, and to run an iSCSI target service program corresponding to the IP address.

19. The iSCSI controller according to claim 17, wherein the recovery processing module comprises:
a recovery detection module adapted to send a failure recovery indication upon detection of that the iSCSI controller recovers from failure; and
an IP address configuration module adapted to receive the failure recovery indication sent from the recovery detection module, to configure an IP address over a service network port of the iSCSI controller, and to run an iSCSI target service program corresponding to the IP address.

20. A data transfer system, comprising:
an iSCSI controller communicating with an iSCSI host, wherein the iSCSI controller is operable to:
detect, failure of the mirrored iSCSI controller corresponding to the mirror iSCSI controller;
add service information of the mirrored iSCSI controller to the mirror iSCSI controller;
receive a log-in request sent from an iSCSI host which originally has logged in the mirrored iSCSI controller; and
process the log-in request and transferring data with the iSCSI host according to the service information of the mirrored iSCSI controller.

21. The transfer system according to claim 20, wherein the iSCSI controller is operable to:
add the IP address of the mirrored iSCSI controller to a service network port of the mirror iSCSI controller, and running an iSCSI target service program at the added IP address.

22. The transfer system according to claim 21, wherein the iSCSI controller is operable to:
detect that the mirrored iSCSI controller recovers;
disconnect the data transfer with the iSCSI host which originally has logged in the mirrored iSCSI controller; and
disable the iSCSI target service program running at the IP address of the mirrored iSCSI controller over the service network port, and deleting the IP address of the mirrored iSCSI controller over the service network port.
